(19) United States
(12) Patent Application Publication
(10) Pub. No.: US 2013/0338907 A1
(43) Pub. Date: Dec. 19, 2013

(54) Device and Method for Regulating an Internal Combustion Engine

(71) Applicant: Tobias Erbes, Ludwigsburg (DE)

(72) Inventor: Tobias Erbes, Ludwigsburg (DE)

(73) Assignee: Daimler AG, Stuttgart (DE)

(21) Appl. No.: 14/003,573

(22) PCT Filed: Dec. 6, 2011
(86) PCT No.: PCT/EP2011/006096

§ 371 Date: Sep. 6, 2013

(30) Foreign Application Priority Data
Mar. 9, 2011 (DE) 10 2011 013 392.5

(51) Int. Cl. F02D 41/02

(52) U.S. Cl. CPC F02D 41/021
USPC 701/108

(57) ABSTRACT

A method for the adaptive lambda control of an internal combustion engine involves a controller limiting lambda control by a maximum control stroke. A lambda variable is a controlled variable, a metering variable of a metering device is a manipulated variable, and a lambda setpoint variable is a setpoint variable. In addition, an adapter carries out a lambda adaptation, which is limited by a maximum adaptation speed. A control speed of the lambda control is greater than the maximum adaptation speed. The maximum control stroke and/or the maximum adaptation speed is/are a function of a deviation of the lambda variable from the lambda setpoint value.

### BACKGROUND AND SUMMARY OF THE INVENTION

Exemplary embodiments of the present invention relate to a device and method for regulating an internal combustion engine.

German patent document DE 102 21 376 A1 describes a method and a device for controlling an internal combustion engine, wherein an air mass and/or a fuel mass is/are corrected as a function of a signal of a lambda sensor in the exhaust gas of the internal combustion engine.

In addition, German patent document DE 102 48 038 B4 discloses carrying out a correction of an air/fuel ratio of an internal combustion engine as a function of a signal of a lambda sensor, the duration of fuel injection being corrected via a correction coefficient and via a learning correction coefficient. The learning correction coefficient is computed as a function of further correlation parameters, using a complicated sequential method. In addition, the further correlation parameters in each case are delimited in their value range by an upper limit and a lower limit in order to achieve stable behavior. Lastly, an error flagging condition is derived as a function of the further correlation parameters for determining an error in an exhaust gas recirculation system or in a fuel vapor processing system. The method disclosed in German patent document DE 102 48 038 B4 is suitable for improving the accuracy of a control/regulation system for the air/fuel ratio. A disadvantage of the method is that it is extremely complicated, and an error in a mixture formation system of the internal combustion engine is detected only very slowly.

Exemplary embodiments of the present invention are directed to a device and a method for regulating an internal combustion engine, which has a simpler design compared to the prior art and therefore is more cost-effective and easier to parameterize. Exemplary embodiments of the present invention also detect and display an error in a mixture formation system of the internal combustion engine more quickly, so that more stringent regulatory requirements for an on-board diagnostic system may be met.

In accordance with exemplary embodiments of the present invention the device includes a device for the adaptive lambda control of an internal combustion engine of a motor vehicle having a combustion chamber, a metering device for metering at least one component of a combustion mixture into the combustion chamber, and a lambda sensor for measuring a lambda variable of an exhaust gas of the internal combustion engine. The device has a controller that is provided for carrying out a lambda control which is limited by a maximum control stroke, and an adapter that is provided for carrying out a lambda adaptation which is limited by a maximum adaptation speed.

According to exemplary embodiments of the present invention, the controller carries out the lambda control as a function of the maximum control stroke of a deviation of the lambda variable from a lambda setpoint value, and/or the adapter carries out the lambda control as a function of the maximum adaptation speed of a deviation of the lambda variable from the lambda setpoint value.

In accordance with exemplary embodiments of the present invention a method for the adaptive lambda control of an internal combustion engine of a motor vehicle is provided. The internal combustion engine has a combustion chamber, a metering device for metering at least one component of a combustion mixture into the combustion chamber, and a lambda sensor for measuring a lambda variable of an exhaust gas of the internal combustion engine.

The “metering device” is at least one component by means of which the lambda variable of the internal combustion engine may be changed, in particular a throttle valve for metering a quantity of air into the combustion chamber, an injector for metering a quantity of fuel into the combustion chamber over an injection time, a boost pressure controller for varying the quantity of air via a boost pressure, a rail pressure controller for varying the quantity of fuel via a rail pressure, an exhaust gas recirculation valve for metering a quantity of exhaust gas into the combustion chamber, or a swirl flap.

The lambda variable is a controlled variable of a control loop on which the method is based. The “lambda variable” is a lambda value of the exhaust gas of the internal combustion engine measured by the lambda sensor, or a value that is directly correlated with the lambda value. The “lambda value” is a quotient of an oxygen quantity and a fuel quantity of the combustion mixture of the internal combustion engine.

The metering device is an actuator of the control loop for changing a composition of the combustion mixture, and a metering variable of the metering device is a manipulated variable of the control loop. The metering variable is an injection time of the injector and/or the rail pressure and/or a throttle valve position and/or a position of the exhaust gas recirculation valve and/or a boost pressure and/or a position of a swirl flap.

A setpoint value of the control loop is a lambda setpoint variable. According to the method of the present invention, the lambda setpoint variable is predefined as a function of a load of the internal combustion engine and/or a speed and other operating parameters of the internal combustion engine. The lambda setpoint variable is advantageously computed for each operating point of the internal combustion engine, based on a computation model.

According to the method of the present invention, a lambda control is carried out in a known manner by means of a controller, the lambda setpoint variable being compared to the lambda variable, and a deviation of the measured lambda variable from the predefined lambda setpoint variable being responded to with a correction instruction. By means of the correction instruction, the metering variable is changed in such a way that the lambda variable is essentially equal to the lambda setpoint variable. The controller is part of a control unit that has a memory device in which setpoint variables, among other things, are stored, a processor, and signal connections to sensors and control connections to actuators. The lambda control is limited by a maximum control stroke. The “control stroke” is intended to mean a sum of the changes to the metering variable achieved by means of the correction instructions and/or changes to a correction factor of the metering variable. The control stroke is limited to a maximum value to ensure a stable control response.

A lambda adaptation is carried out by means of an adapter that is likewise part of the control unit. In the lambda adaptation, long-term deviations of the measured lambda variable from the predefined lambda setpoint variable are identified, and parameters of the lambda control are changed as a function of the long-term deviations. An adaptation speed of the lambda adaptation is usually slower than a control speed of the lambda control. The adaptation speed is limited to a maximum adaptation speed, so that for large long-term deviations of the lambda variable from the lambda setpoint variable, the adaptive change of the parameters of the lambda control is made only at a finite speed.

The lambda control and the lambda adaptation each take place in a known manner only when suitable operating conditions of the internal combustion engine are present. Suitable operating conditions depend on parameters such as the speed and/or load of the internal combustion engine.

According to the invention, the maximum control stroke and/or the maximum adaptation speed is/are not fixed, but, rather, is/are variable as a function of a lambda deviation from the lambda setpoint value. The “lambda deviation” is a difference between the lambda variable and the lambda setpoint variable. The maximum control stroke and/or the maximum adaptation speed is/are preferably greater the larger the lambda deviation. The prior art typically uses a fixed maximum adaptation speed and a fixed maximum control stroke to ensure a stable response of the control and the adaptation, and to minimize the level of effort for parameterizing the control and the adaptation. However, the prior art has the disadvantage that, in particular for large, abrupt lambda deviations, the correction only takes place very slowly. Due to the fact that a diagnostic function for detecting system errors is usually also associated with the lambda control and the lambda adaptation, slow error detection also results from a slow lambda control/adaptation. By means of the method presented herein, it is possible, even for large, abrupt lambda deviations, to speed up the correction of the lambda value and the detection of system errors.

In a first refinement of the method of the present invention, the maximum control stroke and/or the maximum adaptation speed is/are a function of a cumulative lambda deviation, the maximum control stroke and/or the maximum adaptation speed being greater the larger the cumulative lambda deviation. The “cumulative lambda deviation” is a summed lambda deviation of the internal combustion engine over the period of time it has operated after being installed in the motor vehicle. In this way, the maximum adaptation speed and/or the maximum control stroke is/are increased not only when there is a large, abrupt lambda deviation, but also when a large cumulative lambda deviation has already occurred based on a past history of the internal combustion engine.

Normally, a system error is deduced when a certain large cumulative lambda correction is present. That is, when a cumulative lambda correction is present that is already in the vicinity of the certain large cumulative lambda correction, the maximum control stroke and/or the maximum adaptation speed is/are advantageously increased, so that a correction speed and thus also a diagnosis speed is increased.

According to the invention, an error of the internal combustion engine is also advantageously displayed when the sum of the achieved control stroke of the lambda control and an adaptation stroke of the lambda adaptation exceeds a stroke threshold value. The “adaptation stroke” is a sum of the changes to the control parameters made by means of the correction instructions. The adaptation stroke may be limited to a maximum value, the same as for the control stroke. The error may also be displayed as a function of the cumulative lambda deviation; however, displaying as a function of the sum of the control stroke and the adaptation stroke is more advantageous, since in this case the presence of the error may be reliably deduced.

In another advantageous refinement the metering device has an exhaust gas recirculation valve for metering a quantity of exhaust gas into the combustion chamber, and the metering of the quantity of exhaust gas is at least part of the manipulated variable. The lambda value may be corrected in a particularly simple and reliable manner by metering the quantity of exhaust gas.

In another advantageous refinement the metering device has fuel metering for metering a fuel into the combustion chamber, and the metering of the fuel is at least part of the manipulated variable. The lambda value may be corrected in a particularly efficient manner by means of the fuel metering.

In another advantageous refinement provides that the metering device has a throttle valve for metering a quantity of air into the combustion chamber, and the metering of the quantity of air is at least part of the manipulated variable. The lambda value may be corrected in a particularly reliable manner by metering the quantity of air.

In another advantageous refinement of the method a first maximum control stroke and a first maximum adaptation speed are present in a first correction mode, and a second maximum control stroke and a second maximum adaptation speed are present in a second correction mode, a switch being made between the first and the second correction mode as a function of the deviation of the lambda value from the lambda setpoint value, and/or as a function of the sum of the control stroke of the lambda control and the adaptation stroke of the lambda adaptation. Due to the division into just two different correction modes, each having associated control and adaptation parameters, the parameterization effort or the application effort may be limited to a minimum. The use of two correction modes is sufficient in most cases for ensuring a stable control and adaptation response on the one hand, and rapid error detection on the other hand. Using further correction modes, each having further maximum control strokes and a further maximum adaptation speed, further optimizes the stability of the control and adaptation response while at the same time optimizing the error detection, but also increases the application effort.

In another advantageous refinement of the method the first maximum control stroke and the first maximum adaptation speed are smaller than the second maximum control stroke and the second maximum adaptation speed, respectively, and that the second correction mode is present when the cumulative lambda deviation is greater than a deviation threshold value of the cumulative deviation of the lambda value.

In another advantageous refinement of the method the switching between the first and the second correction mode depends on the elapsing of a debouncing time. The stability of the control and adaptation response may thus be further increased, since the second correction mode, in which a more dynamic control and adaptation response is present, is switched on only when it is certain that the higher dynamics are also necessary. The debouncing time is advantageously employed in such a way that the second correction mode is used when the cumulative lambda deviation is greater than the deviation threshold value of the cumulative deviation of the lambda value for the duration of the debouncing time.

The invention is described in greater detail based on the following description of exemplary embodiments and with reference to the associated drawings, from which further advantages and features result.

### BRIEF DESCRIPTION OF THE DRAWING FIGURES

The drawings show the following:

FIG. 1 shows a schematic illustration of an internal combustion engine for use of a method according to the invention,

FIG. 2 shows a flow chart for describing a limiting function of the adaptive lambda control according to the invention,

FIG. 3 shows a flow chart for describing a diagnosis according to the invention,

FIG. 4 and FIG. 4a show a function diagram for describing a change over time of important operating parameters in a lambda deviation,

FIG. 5 shows a function diagram in the case of use of a debouncing time, and

FIG. 6 shows a function diagram for a case of two fairly small lambda deviations.

### DETAILED DESCRIPTION

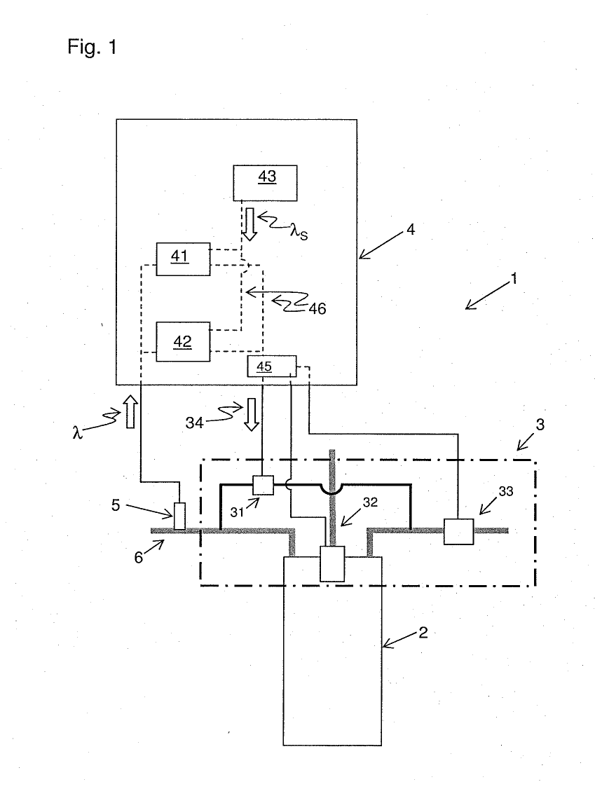

FIG. 1 shows a schematic illustration of an internal combustion engine 1 for use of a method according to the invention for adaptive lambda control of the internal combustion engine 1. The internal combustion engine 1 has a combustion chamber 2 in which a fuel/air mixture may be formed by means of a metering device 3. The metering device 3 has fuel metering 32 for metering a quantity of a liquid or gaseous fuel, a throttle valve 33 for metering a quantity of air, and an exhaust gas recirculation valve 31 for metering a quantity of exhaust gas.

The internal combustion engine 1 also has a lambda sensor 5 for measuring a lambda variable λ in an exhaust gas 6 of the internal combustion engine 1, and a control unit 4 for controlling and regulating operation of the internal combustion engine 1. The lambda variable λ is a lambda value or a value that directly depends on the lambda value. The control unit 4 has a controller 41, an adapter 42, a lambda model 43, and a metering function 45 which are based on known hardware and software for engine control units.

A lambda control is carried out in a known manner by the controller 41, wherein with regard to the lambda control
the lambda variable λ is a controlled variable,
a metering variable 34 of the metering function 45 is a manipulated variable, and
a lambda setpoint variable λ_{S} is a setpoint variable.

The lambda setpoint variable is predefined in the control unit 4 for each operating point as a function of operating conditions of the internal combustion engine 1, by means of the lambda model 43. The controller 41, adapter 42, lambda model 43, metering function 45, and lambda sensor 5 are connected to one another via a data exchange system 46. The metering variable 34 is rapidly corrected via the lambda control, with the objective that the lambda variable λ remains essentially equal to the lambda setpoint variable λ_{S}.

A lambda adaptation is carried out by means of the adapter 42, resulting in a slow correction of the metering variable 34 for adapting the lambda variable λ to the lambda setpoint variable λ_{S}.

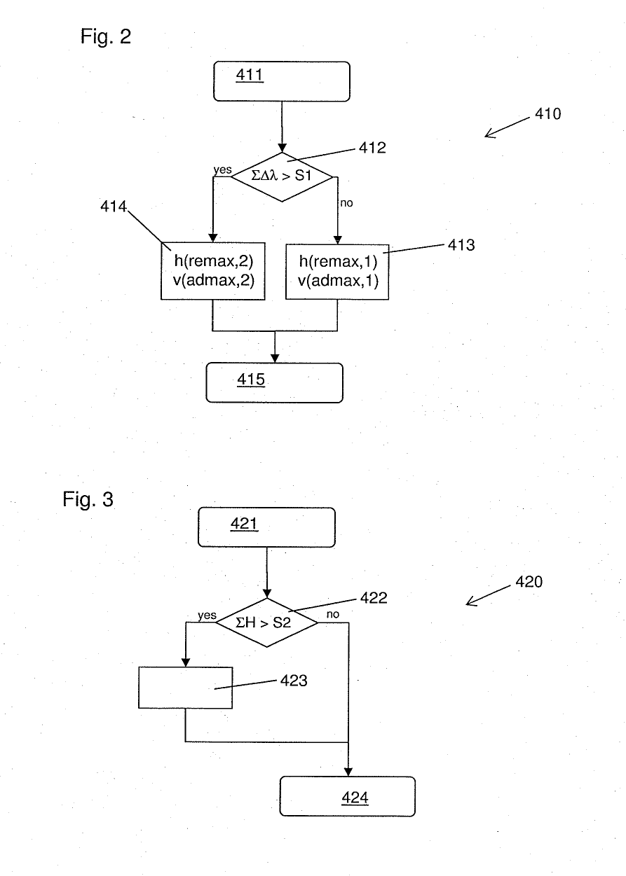

FIG. 2 shows a flow chart of a limiting function 410 of the adaptive lambda control according to the invention.

The lambda control is limited by a maximum control stroke. Due to limiting the control stroke, when there is a large deviation Δλ of the lambda variable λ from the lambda setpoint value λ_{S}, the deviation Δλ is not immediately reduced to a value of zero. The reason for this is that very rapid and large changes in the metering variable 34, which are associated with a very large control stroke, may result in instabilities in the control system, and thus, unstable operation of the internal combustion engine 1.

The lambda adaptation has an adaptation speed limitation, not an adaptation stroke limitation. A maximum adaptation speed ensures that long-term lambda deviations Δλ do not always have to readjusted, but instead are corrected by a correction of control parameters.

According to the invention, the maximum control stroke and/or the maximum adaptation speed is/are a function of the deviation Δλ of the lambda variable λ from the lambda setpoint value λ_{S}.

In an initial step 411 of the limiting function 410, a check is made as to whether suitable operating conditions of the internal combustion engine 1 are present for carrying out the subsequent steps of the limiting function 410. If this is the case, a check is made in a comparative step 412 as to whether a cumulative lambda deviation ΣΔλ is greater than a first threshold value S1. The “cumulative lambda deviation ΣΔλ” is intended to mean a computed overall lambda deviation over the service life of the internal combustion engine 1 up to the instantaneous point in time. The cumulative lambda deviation ΣΔλ is equivalent to an instantaneous lambda deviation that would result if no lambda control and no lambda adaptation were carried out over the service life of the internal combustion engine 1 up to the instantaneous point in time. If the cumulative lambda deviation ΣΔλ is not greater than the first threshold value S1, in a first setting step 413 the maximum control stroke is set to a first maximum control stroke h(remax,1), and the maximum adaptation speed is set to a first maximum adaptation speed v(admax,1). If the cumulative lambda deviation ΣΔλ is greater than the first threshold value S1, in a second setting step 414 the maximum control stroke is set to a second maximum control stroke h(remax,2), and the maximum adaptation speed is set to a second maximum adaptation speed v(admax,2). The limiting function 410 is subsequently carried out again via a return step 415.

FIG. 3 shows a flow chart for describing a diagnosis 420 according to the invention. In an initial step 421 of the diagnosis 420, a check is made as to whether suitable operating conditions of the internal combustion engine 1 are present for carrying out the subsequent steps of the diagnosis 420. If this is the case, in a comparative step 422 of the diagnosis a check is made as to whether a sum ΣH of the control stroke of the lambda control and an adaptation stroke of the lambda adaptation exceeds a stroke threshold value S2. The sum ΣH of the control stroke of the lambda control and the adaptation stroke of the lambda adaptation is equivalent to or directly dependent on the overall correction made to the metering variable 34 of the metering function 45 at the instantaneous point in time in the course of the lambda control and lambda adaptation. If the sum ΣH of the control stroke of the lambda control and the adaptation stroke of the lambda adaptation exceeds the stroke threshold value S2, an error is stored 423 in a memory (not illustrated) of the control unit 4. If the sum ΣH of the control stroke of the lambda control and the adaptation stroke of the lambda adaptation does not exceed the stroke threshold value S2, an error correction (not illustrated) is optionally carried out, or a return step 424 is immediately carried out for again performing the diagnosis 420. The return step 424 is likewise carried out after an error is stored 423.

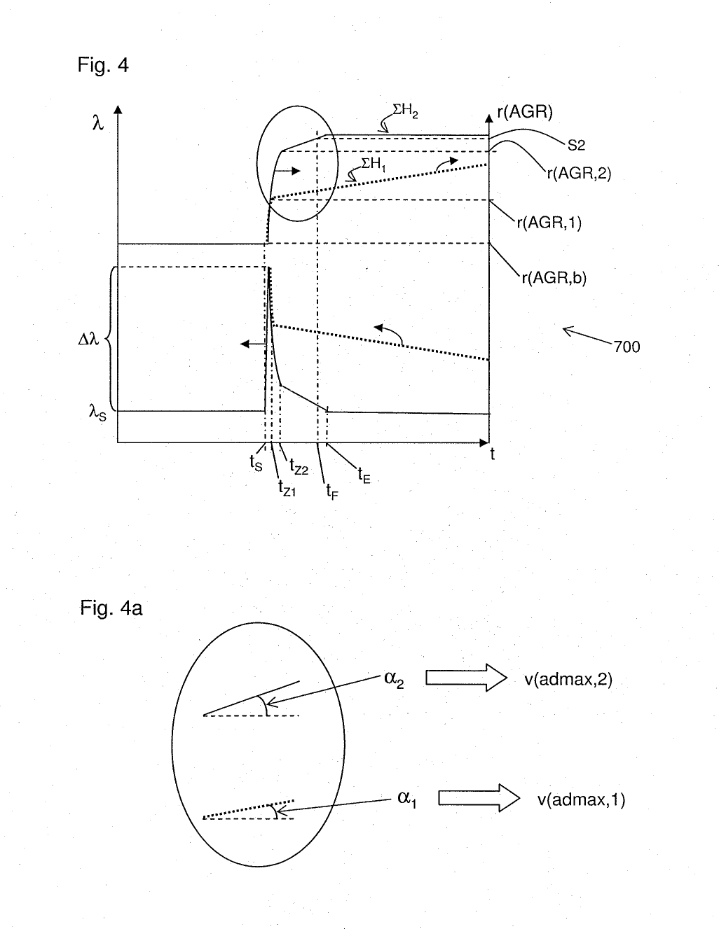

FIG. 4 shows a function diagram 700 for describing a change over time of important operating parameters when a lambda deviation Δλ occurs in the internal combustion engine 1.

The function diagram 700 has a time axis as the abscissa axis, on which the time t is plotted. The lambda variable λ measured by the lambda sensor 5 is plotted on the left ordinate axis, and an exhaust gas recirculation rate r(AGR) is plotted on a right ordinate axis. The “exhaust gas recirculation rate r(AGR)” is a percentage of the exhaust gas 6 of the internal combustion engine 1 which is returned back into the combustion chamber 2.

The curve illustrated in the function diagram 700 describes a change over time of the lambda variable λ and of the exhaust gas recirculation rate r(AGR) at a constant load and a constant speed of the internal combustion engine 1. At the start of the curve, disturbance-free operation of the internal combustion engine 1 is present: the lambda variable λ corresponds to a lambda setpoint variable λ_{S} that is predefined under the given operating conditions, and the exhaust gas recirculation rate r(AGR) corresponds to a base recirculation rate r(AGR,b). At a disturbance point in time t_{S}, reduced fuel metering occurs due to a defect in the fuel metering 32 of the internal combustion engine 1, resulting in an abrupt increase in the lambda variable λ by the lambda deviation Δλ.

A distinction is made between two cases in the further progression of the function diagram:
a first curve, indicated by dotted-line curves, for a conventional adaptive lambda control, and
a second curve, indicated by solid-line curves, for an adaptive lambda control according to the invention.

In the case of the conventional adaptive lambda control (dotted lines), immediately after the increase in the lambda variable λ by the lambda deviation Δλ, the exhaust gas recirculation rate r(AGR) increases, as is apparent from a steep increase in the top dotted-line curve. The steep increase in the exhaust gas recirculation rate r(AGR) results from a rapid correction by the controller 41, which, however, is limited by a first maximum control stroke h(remax,1). The exhaust gas recirculation rate r(AGR) is corrected to a first corrected value r(AGR,1) due to the first maximum control stroke h(remax,1). Corresponding to the correction of the exhaust gas recirculation rate r(AGR) to the first corrected value r(AGR,1), at a first intermediate point in time t_{Z1} the lambda variable λ has once again changed in the direction of the lambda setpoint variable, as shown by the bottom dotted line in FIG. 4. Since the maximum control stroke h(remax,1) is depleted at the first intermediate point in time t_{Z1}, after the first intermediate point in time t_{Z1} there is no further rapid correction of the exhaust gas recirculation rate r(AGR); instead, a speed of the further correction, namely, a slope (tan α1 in FIG. 4a) of the top dotted-line curve, is determined by a first speed v(admax,1) of the lambda adaptation. α1 is an angle between the top dotted-line curve and the abscissa axis after the first intermediate point in time t_{Z1}.

In the case of the adaptive lambda control according to the invention (solid lines), immediately after the increase in the lambda variable λ by the lambda deviation Δλ, a much greater increase in the exhaust gas recirculation rate r(AGR) occurs, namely, up to the second corrected value r(AGR,2). This is because the lambda deviation Δλ is very large, and therefore the cumulative lambda deviation ΣΔλ is also greater than the first threshold value, so that the control stroke is now carried out up to the second maximum control stroke h(remax,2). As a result, up to a second intermediate point in time t_{Z2} the lambda variable λ drops almost back to the lambda setpoint variable λ_{S}. After the second intermediate point in time t_{Z2}, the exhaust gas recirculation rate r(AGR) is corrected more rapidly in the adaptive lambda control according to the invention (solid line) compared to the conventional adaptive lambda control, as shown by a steeper slope (tan α2 in FIG. 4a) of the top solid line, which is due to a larger second maximum adaptation speed v(admax,2). α2 is an angle between the top solid line and the abscissa axis after the second intermediate point in time t_{Z2}. After the second intermediate point in time t_{Z2}, the adaptation speed in the case of the solid line is equal to the second maximum adaptation speed v(admax,2), since a large lambda deviation yet to be corrected still remains.

The change in the exhaust gas recirculation rate r(AGR) over time t, i.e., the top solid-line curve and the top dotted-line curve, corresponds directly or indirectly to the sum ΣH of the control stroke of the lambda control and the adaptation stroke of the lambda adaptation.

Due to the large second maximum control stroke h(remax,2) and the large second maximum adaptation speed v(admax,2), the top solid line exceeds the stroke threshold value S2 within a comparatively short time, namely, at an error storage point in time t_{F}. This exceeding of the threshold value is an error flagging criterion represented in FIG. 3, and error information is stored in the error memory of the control unit 4 at the error storage point in time t_{F}. At an end point in time t_{E} the correction of the lambda variable is continued until the lambda setpoint variable λ_{S} is reached.

In the case of the conventional adaptive lambda control (dotted lines), after the first intermediate point in time t_{Z1} the exhaust gas recirculation rate r(AGR) slowly increases, and the lambda variable λ slowly approaches the lambda setpoint variable λ_{S}, so that an error detection, i.e., exceeding the stroke threshold value S2, does not occur until much later than the error storage point in time t_{F} of the method according to the invention.

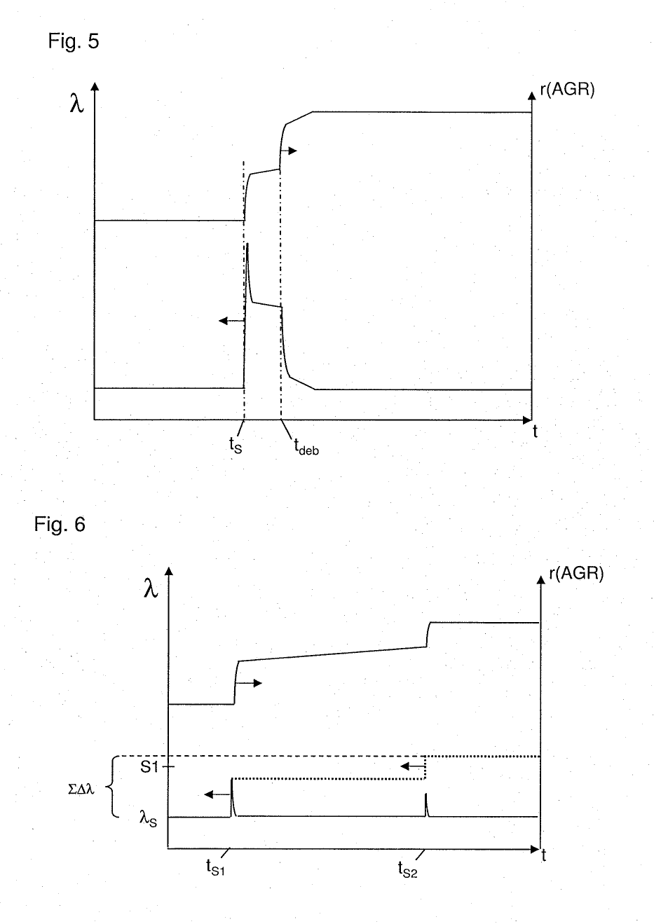

FIG. 5 shows a function diagram in the case of use of a debouncing time. In the case described by FIG. 5, a first correction mode at a first maximum adaptation speed v(admax,1) and a first maximum control stroke h(remax,1) is carried out at the disturbance point in time t_{S}. Only if the disturbance is still present at a debouncing point in time t_{deb} is a switch made to a second correction mode, and the maximum control stroke is increased to the second maximum control stroke h(remax,2), and the maximum adaptation speed is increased to the second maximum adaptation speed v(admax,2). The other conditions correspond to those in FIG. 4.

FIG. 6 shows a function diagram for a case of two fairly small lambda deviations. At a point in time t_{S1} of a first disturbance, a first lambda deviation occurs, followed by a correction according to the invention of the exhaust gas recirculation rate r(AGR), as described above. A second lambda deviation occurs at a point in time t_{S2} of a second disturbance. Only at the point in time t_{S2} of the second disturbance does the cumulative lambda deviation ΣΔλ become large enough for the first threshold value S1 to be exceeded, and the switch is made to the second correction mode. The other conditions correspond to those in FIG. 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE CHARACTERS

1 Internal combustion engine
2 Combustion chamber
3 Metering device
31 Exhaust gas recirculation valve
32 Fuel metering
33 Throttle valve
34 Metering variable
4 Control unit
41 Controller
42 Adapter
43 Lambda model
45 Metering function
46 Data exchange system
410 Limiting function
411 Initial step of the limiting function
412 Comparative step of the limiting function
413 First setting step of the limiting function
414 Second setting step of the limiting function
415 Return step of the limiting function
420 Diagnosis
421 Initial step of the diagnosis
422 Comparative step of the diagnosis
423 Error storage
424 Return step of the diagnosis
5 Lambda sensor
6 Exhaust gas
700 Function diagram
h(remax,1) First maximum control stroke
h(remax,2) Second maximum control stroke
ΣH Sum of control stroke and adaptation stroke
ΣΔλ Cumulative lambda deviation
Δλ Lambda deviation
λ Lambda variable
λ_{S} Lambda setpoint variable
r(AGR) Exhaust gas recirculation rate
r(AGR,b) Base exhaust gas recirculation rate
r(AGR,1) First corrected value of the exhaust gas recirculation rate
r(AGR,2) Second corrected value of the exhaust gas recirculation rate
S1 First threshold value
S2 Stroke threshold value
t Time
t_{deb} Debouncing point in time
t_{E} End point in time
t_{F} Error storage point in time
t_{S} Disturbance point in time
t_{S1} Point in time of a first disturbance
t_{S2} Point in time of a second disturbance
t_{Z1} First intermediate point in time
t_{Z2} Second intermediate point in time
v(admax,1) First maximum adaptation speed
v(admax,2) Second maximum adaptation speed

1-9. (canceled)

10. A device for the adaptive lambda control of an internal combustion engine, the device comprising:
a combustion chamber;
a metering device configured to meter at least one component of a combustion mixture into the combustion chamber;
a lambda sensor configured to measure a lambda variable of an exhaust gas of the internal combustion engine;
a controller configured to perform a lambda control limited by a maximum control stroke; and
an adapter configured to perform a lambda adaptation limited by a maximum adaptation speed,
wherein the controller is configured to perform the lambda control as a function of a maximum control stroke of a deviation of the lambda variable from a lambda setpoint variable, or the adapter is configured to perform the lambda adaptation as a function of a maximum adaptation speed of the deviation of the lambda variable from the lambda setpoint variable.

11. The device according to claim 10, wherein the metering device includes:
an exhaust gas recirculation valve configured to meter a quantity of exhaust gas into the combustion chamber;
a fuel meter configured to meter a fuel into the combustion chamber; or
a throttle valve configured to meter a quantity of air into the combustion chamber.

12. A method for the adaptive lambda control of an internal combustion engine, having a combustion chamber, the method comprising:
metering, by a metering device, at least one component of a combustion mixture into the combustion chamber;
measuring, by a lambda sensor, a lambda variable of an exhaust gas of the internal combustion engine;
performing, by a controller, a lambda control limited by a maximum control stroke; and
performing, by an adapter, a lambda adaptation limited by a maximum adaptation speed,
wherein a control speed of the lambda control is greater than the maximum adaptation speed,
the lambda variable is a controlled variable of the lambda control,
a metering variable of the metering device is a manipulated variable of the lambda control,
a lambda setpoint variable is a threshold value of the lambda control, and
the maximum control stroke or the maximum adaptation speed is a function of a deviation of the lambda variable from the lambda setpoint variable.

13. The method according to claim 12, wherein a metering of a quantity of exhaust gas, a fuel, or a quantity of air is at least part of the manipulated variable of the lambda control.

14. The method according to claim 12, wherein the maximum control stroke or the maximum adaptation speed is a function of a cumulative lambda deviation, wherein the maximum control stroke or the maximum adaptation speed increases as the cumulative lambda deviation increases.

15. The method according to claim 12, further comprising:
storing an error of the internal combustion engine when a sum of a control stroke of the lambda control and an adaptation stroke of the lambda adaptation exceeds a stroke threshold value.

16. The method according to claim 12, wherein a first maximum control stroke and a first maximum adaptation speed are present in a first correction mode, and a second maximum control stroke and a second maximum adaptation speed are present in a second correction mode, and
wherein a switch is made between the first and the second correction mode as a function of a cumulative lambda deviation, or as a function of a sum of the control stroke of the lambda control and the adaptation stroke of the lambda adaptation.

17. The method according to claim 16, wherein the first maximum control stroke and the first maximum adaptation speed are smaller than the second maximum control stroke and the second maximum adaptation speed, respectively, and
wherein the second correction mode is present when the cumulative lambda deviation is greater than a first threshold value of the cumulative deviation of the lambda variable.

18. The method according to claim 17, wherein the switching between the first and the second correction mode depends on the elapsing of a debouncing time.
